(19) United States
(12) Patent Application Publication
(10) Pub. No.: US 2012/0268414 A1
(43) Pub. Date: Oct. 25, 2012

(54) METHOD AND APPARATUS FOR EXCHANGING DATA WITH A USER COMPUTER DEVICE

(75) Inventors: Rachid M. Alameh, Crystal Lake, IL (US); John Henry Krahenbuhl, McHenry, IL (US); Thomas Y. Merrell, Beach Park, IL (US); Martin R. Pais, North Barrington, IL (US); Jiri Slaby, Buffalo Grove, IL (US)

(73) Assignee: MOTOROLA MOBILITY, INC., Libertyville, IL (US)

(21) Appl. No.: 13/093,211

(22) Filed: Apr. 25, 2011

(51) Int. Cl. G06F 3/045

(52) U.S. Cl. 345/174

(57) ABSTRACT

A communication system is provided that allows a user to exchange a stream of data with a user computer device via a capacitive touchscreen of the device. The communication system includes a user's data input device having a capacitive user interface and a user computer device having a capacitive touchscreen. When the capacitive user interface of the data input device and the capacitive touchscreen of the user computer device are in sufficient to proximity to each other, an inter-device capacitance is created over which exchanging a stream of data may be exchanged between the data input device and the user computer device.

### FIELD OF THE INVENTION

The present invention relates generally to user computer devices and, in particular, to a user computer device having a capacitive touchscreen and to an exchange of data via the touchscreen.

### BACKGROUND OF THE INVENTION

Currently, wireless communication devices, such as a cellular telephone, a smartphone, or a personal digital assistant with wireless capabilities, can exchange data with each other by use of short-range wireless technologies such as Bluetooth, wireless infrared communications, or Wi-Fi. However, these systems require radio frequency (RF) circuitry for such an exchange of communications and, in transmitting such signals, consume power to wirelessly transmit a signal and are exposed to environmental interference. Furthermore, wireless transmissions require authentication and device discovery-pairing. A user of a wireless communication device also may input an instruction into the wireless communication device by utilizing an ability of the device's touchscreen to detect a location of a touch, for example, by the user touching a icon displayed on the touchcreen or by the user writing out a symbol on the touchcreen with the user's finger or a stylus. However, a mere touching does not allow for the user to exchange a stream of data with the device and inputting instructions by writing with a finger or stylus can be cumbersome and slow.

Therefore, a need exists for a user, or more particularly a user device such as a stylus that interacts with a wireless communication device's touchscreen, to exchange data with the wireless communication device in a more efficient manner.

### BRIEF DESCRIPTION OF THE DRAWINGS

FIG. 1 is a block diagram of an exemplary communication system in accordance with an embodiment of the present invention.

FIG. 2 is a block diagram of an exemplary communication system in accordance with another embodiment of the present invention.

FIG. 3 is a block diagram of an exemplary user computer device in accordance with an embodiment of the present invention.

FIG. 4 is a block diagram of an exemplary user computer device stylus in accordance with an embodiment of the present invention.

FIG. 5 is a block diagram of an exemplary user computer device stylus in accordance with another embodiment of the present invention.

FIG. 6 is a logic flow diagram illustrating an exchange of data via an inter-device capacitance in accordance with an embodiment of the present invention.

### DETAILED DESCRIPTION OF THE INVENTION

To address the need for a method and apparatus for a user, or more particularly a user device such as a stylus that interacts with a wireless communication device's touchscreen, to exchange data with the wireless communication device in a more efficient manner than provided in the prior art, a communication system is provided that allows a user to exchange a stream of data with a user computer device via a capacitive touchscreen of the device. The communication system includes a user's data input device having a capacitive user interface and a user computer device having a capacitive touchscreen. When the capacitive user interface of the data input device and the capacitive touchscreen of the user computer device are in sufficient to proximity to each other, an inter-device capacitance is created over which exchanging a stream of data may be exchanged between the data input device and the user computer device.

Generally, an embodiment of the present invention encompasses a method for exchanging data with a user computer device. The method includes creating an inter-device capacitance, wherein a capacitive touchscreen of the user computer device comprises a conductor of the inter-device capacitance, and exchanging one or more streams of data with a device external to the user computer device via the capacitive touchscreen and the inter-device capacitance to produce one or more exchanged data streams.

Another embodiment of the present invention encompasses a user computer device having a capacitive touchscreen and a processor that is configured to establish an inter-device capacitance, via the capacitive touchscreen, with a device external to the user computer device and to exchange, with the device external to the user computer device and via the inter-device capacitance and the capacitive touchscreen, one or more streams of data to produce to produce one or more exchanged data streams.

Yet another embodiment of the present invention encompasses a communication system comprising a data input device having a capacitive user interface and a user computer device having a capacitive touchscreen, wherein the data input device and the user computer device exchange a stream of data via an inter-device capacitance between the capacitive user interface of the data input device and the capacitive touchscreen of the user computer device.

Turning now to the drawings, the present invention may be more fully described with reference to FIGS. 1-6. FIG. 1 is a block diagram of an exemplary communication system 100 in accordance with an embodiment of the present invention. Communication system 100 includes a user computer device 102 and a user's data input device 110. In the embodiment depicted in FIG. 1, the user's data input device is a user computer device stylus. User computer device 102 may be any user computer device that allows a user to input instructions to the device via a capacitive touchscreen 104 and, optionally, may be capable of sending and receiving communication signals on a wireless network. Preferably, user computer device 102 is a wireless mobile device, such as a cellular telephone, a radio telephone, a smart phone, or a personal digital assistant (PDA), a laptop computer or a tablet computer with radio frequency (RF) capabilities, or any other handheld or portable electronic device with a user interface comprising a capacitive touchscreen 104 that allows a user to input data into the user computer device; however, user computer device 102 may be any type of user computer device, such as a personal computer or a laptop or tablet computer without wireless capabilities, that has a user interface that includes a capacitive touchscreen.

User computer device stylus 110 allows a user to interact with touchscreen 104. Preferably, user computer device stylus 110 is a capacitive stylus, such as a multi-touch stylus, a stylus pen, or any other type of user utensil that includes a capacitive user interface, for example, a conductive tip 112, that allows a user to input instructions into a user computer device via a capacitive touchscreen of the user computer device.

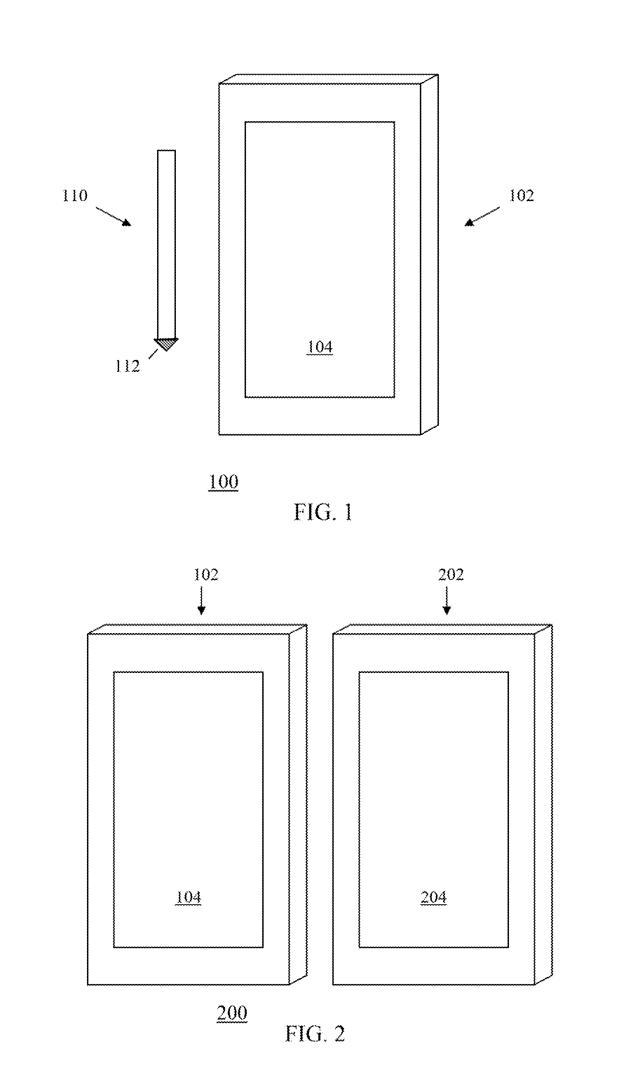

FIG. 2 is a block diagram of an exemplary communication system 200 in accordance with another embodiment of the present invention. Similar to the embodiment depicted in FIG. 1, communication system 200 comprises a first user computer device, that is, user computer device 102. However, in the embodiment depicted in FIG. 2, the user's data input device comprises a second user computer device 202. Second user computer device 202 may be any user computer device that includes a user interface having a capacitive touchscreen 204, and preferably is a wireless communication device that is capable of sending and receiving communication signals on a wireless network. For example, user computer device 202 may be a mobile device, such as a cellular telephone, a radio telephone, a smart phone, or a personal digital assistant (PDA), a laptop computer or tablet computer with radio frequency (RF) capabilities, or any other handheld or portable electronic device with a user interface comprising a capacitive touchscreen.

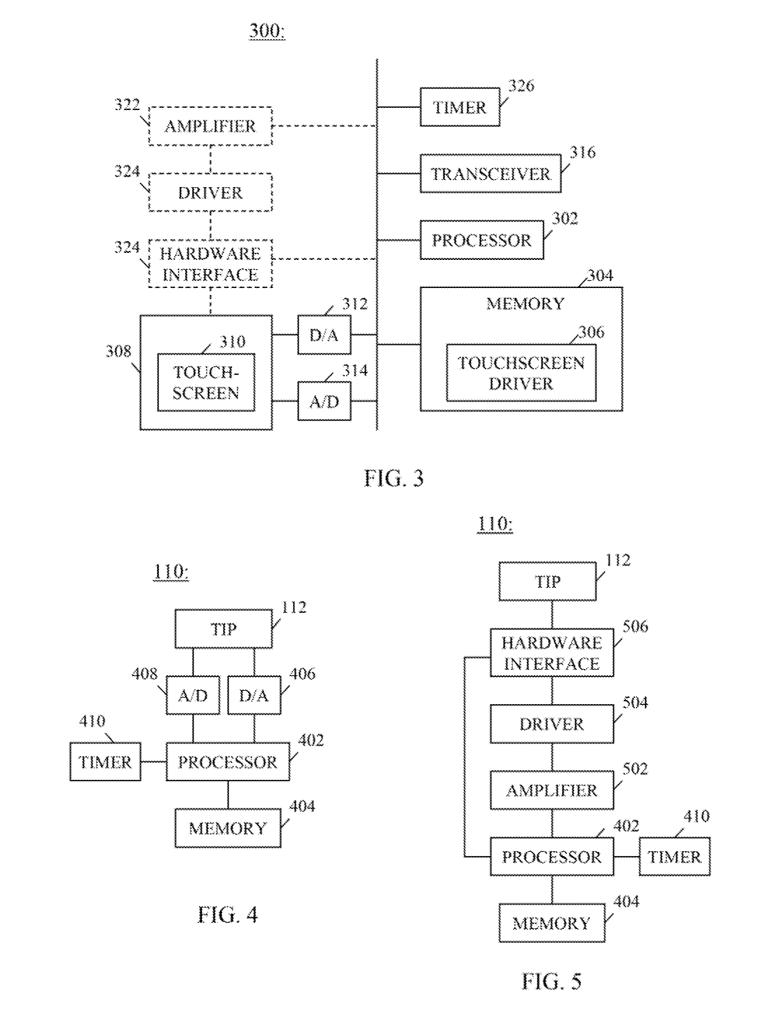

Referring now to FIGS. 3-5, block diagrams are depicted of a user computer device 300, such as user computer devices 102 and 202, and user computer device stylus 110 in accordance with various embodiments of the present invention. Each of user computer device 300 and user computer device stylus 110 includes a respective processor 302, 402 such as one or more microprocessors, microcontrollers, digital signal processors (DSPs), combinations thereof or such other devices known to those having ordinary skill in the art. The particular operations/functions of processors 302, 402, and respectively thus of user computer device 300 and user computer device stylus 110, are determined by an execution of software instructions and routines that are stored in a respective at least one memory device 304, 404 associated with the processor, such as random access memory (RAM), dynamic random access memory (DRAM), and/or read only memory (ROM) or equivalents thereof, that store data and programs that may be executed by the corresponding processor. However, one of ordinary skill in the art realizes that the operations/functions of processors 302 and 402 alternatively may be implemented in hardware, for example, integrated circuits (ICs), application specific integrated circuits (ASICs), a programmable logic device such as a PLD, PLA, FPGA or PAL, and the like, implemented in the user computer device. Based on the present disclosure, one skilled in the art will be readily capable of producing and implementing such software and/or hardware without undo experimentation.

Referring now to FIG. 4, processor 402 of user computer device stylus 110 may be coupled to capacitive tip 112 via a digital-to-analog converter (D/A) 406 that converts a digital signal output by processor 402 to an analog signal that is conveyed to user computer device 102 via capacitive tip 112 and an inter-device capacitance, as described in greater detail below, and via an analog-to-digital converter (A/D) 408 that converts an analog signal received via an inter-device capacitance and capacitive tip 112 to a digital signal that is conveyed to processor 402 for further processing. In another embodiment of the present invention, and referring now to FIG. 5, the data communication between the touchscreen 104 of user computer device 102 and the stylus 110 may be digitally encoded. In this case, processor 402 output drives an amplifier stage 502, a driver stage 504 coupled to the amplifier stage, and an interface hardware stage 506 (instead of an A/D, D/A) coupled to the driver stage, processor, and stylus tip 112. In still other embodiments of the present invention, stylus 110 may be capable of both analog and digital communications with touchscreen 104 of user computer device 102 and may include the components depicted in both FIGS. 4 and 5.

Referring now to FIG. 3, user computer device 300 further includes a user interface 308 and, optionally, a transceiver 316 that are each coupled to processor 302. Transceiver 316 includes a wireless receiver (not shown) and a wireless transmitter (not shown) for receiving wireless signals from, and transmitting wireless signals to, another wireless communication device via a corresponding wireless link. User interface 308 includes a display screen that comprises a capacitive touchscreen 310, such as touchscreens 104 and 204, and further may include a keypad, buttons, a touch pad, a joystick, an additional display, or any other device useful for providing an interface between a user and an electronic device such as user computer device 300. The display screen may be a liquid crystal display (LCD), a light emitting diode (LED) display, a plasma display, or any other means for visually displaying information.

User computer device 300 further includes a touchscreen driver 306 that is maintained in at least one memory device 304 and that is executed by processor 302. Touchscreen driver 306 comprises data and programs that control an operation of touchscreen 310, such as sensing a capacitive change in the touchscreen and determining a location of a touch on the touchscreen, and that may reconfigure an operation of the touchscreen as described in greater detail below. User computer device 300 also may include a D/A 312 that converts a digital signal output by processor 302 to an analog, alternating current signal that is routed to touchscreen 310 for conveyance via an inter-device capacitance and an A/D 314 that converts an analog signal received by touchscreen 310 via an inter-device capacitance to a digital signal that is routed to processor 302 for further processing. However, as noted above, in another embodiment of the present invention, the data communication between the touchscreens of user computer devices 102 and 104 or between the touchscreen of user computer device 102 and tip 112 of stylus 110 may be digital encoded. In the case of digitally encoded communications, processor 302 output may drive an amplifier stage 322, a driver stage 324 coupled to the amplifier stage, and an interface hardware stage 326 (instead of an A/D, D/A) coupled to the driver stage, processor, and touchscreen 310 (for example, an ITO conductor associated with the touchcreen). In still other embodiments of the present invention, user communication device 300 may be capable of both analog and digital communications with a touchscreen of another user computer device or with stylus 112 and include components appropriate for both such analog and digital communications.

Touchscreen 310 is a capacitive touchscreen that includes a touchscreen panel as is known in the art. For example, a typical capacitive touchscreen panel includes an insulator, such as glass, that is coated, on an inner surface, with a transparent electrical conductor, such as indium tin oxide (ITO). In other examples of a capacitive touchscreen, the electrical conductor of touchscreen 310 may comprise a grid-type pattern of metallic electrodes that may be embedded in the insulator or etched in a conductor coupled to an inner surface of the touchscreen. The electrical conductor is, in turn, coupled processor 302 and is controlled by touchscreen driver 306. Touching the outer, uncoated surface of the insulator of the touchscreen with an electrical conductor, such as a human body or a capacitive stylus such as stylus 110, results in a change in an electrostatic field and a corresponding change in capacitance that is detected by touchscreen driver 306.

For example, in one type of capacitive touchscreen, a voltage may be applied to the touchscreen's inner surface conductor(s). When a conductor conductive body, such as a human body or a capacitive stylus, touches the outer surface of the touchscreen, a capacitance is created or altered. Processor 302, executing touchscreen driver 306, detects the creation or alteration of the capacitance and is able to determine, based on the detected capacitance, a location of the touch on the touchscreen. For example, the location of the touch may be determined from a variation in the changes in capacitance as measured from the corners of the touchscreen panel. By way of another example, when the touchscreen includes a grid-type pattern (rows and columns) of metallic electrodes, a voltage is applied to the rows and/or columns of the grid. Sensor 314 then may determine a location of the touch based on capacitance changes at each individual point in the grid.

By way of yet another example, touchscreen 310 may be a thermally sensitive mobile device touchscreen as described in U.S. patent application No. 12/774,509, attorney docket no. CS37431, entitled “Mobile Device with Temperature Sensing Capability and Method of Operating Same,” and filed on May 5, 2010, and which description of a thermally sensitive mobile device touchscreen is hereby incorporated herein. For example, a thermally sensitive mobile device touchscreen may include, or may be attached to, multiple temperature sensing devices for example, thermocouples, such as a thermocouple formed by a respective junction of first and second types of materials such as a Indium Tin Oxide (InSnO₄) ceramic material (ITO) and a Indium Tin Oxide Manganese ceramic material (ITO:Mn), that are distributed throughout the touchscreen (in a different plane or intermixed with the capacitive touchscreen). Certain temperature sensing devices may be linked to each other by a graphite strip or other thermally-conductive strip so as to maintain the temperature sensing devices at a same or substantially a same temperature, which temperature may be set at a temperature level different from that of an item that will touch the touchscreen, such as an exposed finger, a gloved finger, or a stylus. The temperature sensing devices also may be electrically connected in series to enhance touch sensitivity as well as to enable differential drive functionality. Junctions connected in series result in alternating junction polarities due to thermocouple conductor type order. Junctions in phase are grouped together for additive response and those with opposite polarities are separated and in some cases used to drive opposing device sides for differential response. In yet other cases, opposing polarity junctions are kept at a known and same temperature for reference and are enabled by applying a Graphite type material in their vicinity. By grouping same polarity junctions, touch sensitivity is enhanced. As a result, when two of the temperature sensing devices that share a same polarity each experience a same temperature, the voltages generated by the temperature sensing devices all tend to increase (or decrease) generally uniformly and tend to be additive, and the resulting output voltage experienced at terminals connected to the temperature sensing devices (which voltage is, in turn, read by processor 302 implementing touchscreen driver 306) will be the sum of the contributions from those temperature sensing devices. Whereas when two of the temperature sensing devices that are of opposite polarity each experience a same temperature, a voltage increase (or decrease) generated by one of the temperature sensing device due to the particular temperature will tend to be offset by a corresponding voltage increase (or decrease) generated by the other of the temperature sensing device. Thus processor 302 is able to determine a location of a touch based on temperature differentials.

In the prior art, a user was limited to communicating a position of a user's touch on a capacitive touchscreen of a target user computer device. A user would have used any dumb device, such as a user's finger, a writing pen, or a mechanical stylus, to communicate the position. In contrast to the simple system of the prior art, communication systems 100 and 200 provide a much broader and richer user experience by allowing a user to exchange a stream of data with a target user computer device via the device's capacitive touchscreen. More particularly, communication systems 100 and 200 provide for the capacitive touchscreen 104 of a target user computer device 102 to operate as a conductor of an inter-device capacitance, wherein the other conductor of the inter-device capacitance is the capacitive touchscreen or capacitive tip of the user's data input device 110, 202. Thus, a user may exchange a stream of data with a target user computer device by conveying, or receiving, an alternating current signal or a digitally encoded signal, comprising a stream of data, exchanged over a capacitive coupling, that is, an inter-device capacitance, between the user's data input device and the target user computer device's capacitive touchscreen. Further, communication over a capacitive coupling between devices could be one-way or two-way. Two-way communication could be simultaneous (encoded streams) or could be serialized, for example, by utilizing a TDMA (Time Division Multiple Access) topology.

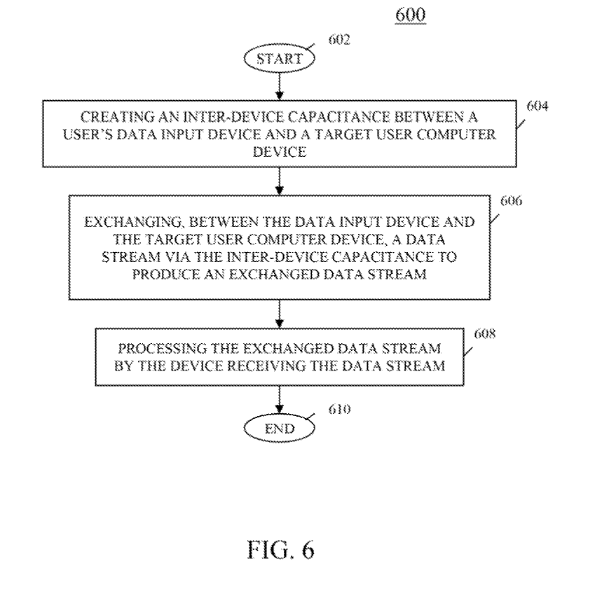

Referring now to FIG. 6, a logic flow diagram 600 is provided that illustrates an exchange of data via an inter-device capacitance in accordance with an embodiment of the present invention. Logic flow diagram 600 begins (602) when a user of a data input device, such as user computer device stylus 110 or user computer device 202, uses the device to create (604) an inter-device capacitance with a capacitive touchscreen, such as touchscreen 104, of a target user computer device, such as user computer device 102. For example, the user may touch touchscreen 104 with the capacitive tip 112 of stylus 110 or with the touchscreen 204 of user computer device 202, or the user may merely bring capacitive tip 112 or touchscreen 204 within sufficient proximity of touchscreen 104 so as to create an inter-device capacitance between capacitive tip 112 or touchscreen 204 of the user's data input device and touchscreen 104 of the target user computer device.

Each of the capacitive interface of the user of a data input device, such as capacitive tip 112 of user computer device stylus 110 or the electrical conductor of capacitive touchscreen 204 of user computer device 202, and the electrical conductor of the capacitive touchscreen 104 of the user computer device 102 functions as a conductor of the inter-device capacitance, with the insulator, such as glass, of the capacitive touchscreen(s) 104, 204 and any intervening air interface between the user's data input device 110, 204 and user computer device 102, serving as the dielectric of the inter-device capacitance. In response to creating the inter-device capacitance, the user's data input device and target user computer device 102 exchange (606), via the capacitive user interface 112, 204 of the user's data input device 110, 202, the inter-device capacitance, and the capacitive touchscreen 104 of the target user computer device 102, an alternating current signal or a digitally encoded signal comprising a stream of data, to produce an exchanged data stream. The recipient of the data stream then processes (608) the exchanged data stream and logic flow 600 then ends (610).

To trigger a commencement of a data communication between a user computer device stylus, or a user's data input device that comprises a thermally sensitive user computer device touchscreen, and a target user computer device touchscreen when in proximity/touch with one another, and further to distinguish the capacitive stylus from a normal finger touch (where data communication is not required), a temperature ITO associated with the target user computer device touchscreen may sense a user settable stylus, or user's data input device thermally sensitive touchscreen, temperature (when the two are in contact). A temperature authentication level or a temperature pattern maintained in at least one memory devices 304 and 404 can be used to detect the proximity of another user computer device touchscreen or of stylus 110 and trigger a commencement of the data communication over a capacitive coupling between devices (for example, between capacitive tip 112 of stylus 110 and touch screen 104 of user computer device 102 or between touchscreens 104 and 204 of user computer devices 102 and 202). The physical contact embodiment between user computer devices or between a user computer device and a user computer device stylus to communicate data (as opposed to longer range wireless interface, for example, over Bluetooth) has the advantages of ad hoc communication and proximity-based privacy (for example, where a user is in control of both devices as opposed to the devices being located in a different rooms, etc.).

For example, with respect to user computer device stylus 110, processor 402 of the stylus may generate a data stream that is converted to an alternating current by D/A 406. User computer device stylus 110 then conveys the alternating current to capacitive touchscreen 104 of target user computer device 102 via capacitive tip 112 and the inter-device capacitance. In response to receiving the alternating current, target user computer device 102 routes the alternating current to processor 302 of the target user computer device via A/D 314, which A/D converts the current to a digital signal that is further processed by processor 302.

By way of another example, processor 302 of target user computer device 102 may generate a data stream that is converted to an alternating current by A/D 314. The target user computer device then conveys the alternating current to capacitive tip 112 of user's data input device 110 via capacitive touchscreen 310 of target user computer device 102 and the inter-device capacitance. In response to receiving the alternating current, the user's data input device routes the alternating current to processor 402 of the user's data input device via A/D 408, which A/D converts the current to a digital signal that is further processed by processor 402.

By way of yet another example, with respect to user computer device 202, when touchscreens 104 and 204 of respective user computer devices 102 and 202 are placed in contact with each other, or at least in sufficient proximity to each other so as to create an inter-device capacitance between the two touchscreens, the touchscreen drivers 306 of each device 102, 202 (as executed by the respective processors 302 of each device) may detect this condition and automatically reconfigure each devices' respective touchscreen 104, 204 so as to create, in effect, a touchcreen that operates as, that is, that emulates, a single capacitive conductor over its entirety (large single conductor) or multiple large conductors, as opposed to a separate conductor at each intersecting point in the touchscreen's electrode grid of rows and columns. For example, the touchscreen drivers 306 of each device 102, 202 may detect such a condition based on a similar capacitance detected at multiple points distributed throughout the touchscreen's grid of rows and columns, on a detected variation in capacitance throughout the device's touchcreen (for example, when the detected variation is below a threshold, indicating that a similar capacitance is being created across the breadth of the device's touchscreen), or on a nearly identical change in the electrical fields associated with multiple points distributed throughout the device's touchscreen. By reconfiguring each devices' touchscreen 104, 204 so as to create, in effect, a touchcreen that operates as a single capacitive conductor over its entirety or as multiple large conductors, an acceptable range or distance of detection and alignment between devices is improved, that is, a greater distance between devices, and/or a greater misalignment of the devices, may be acceptable for creation of the inter-device capacitance employed herein. Further, a quantity of intersecting points in the touchscreen's electrode grid of rows and columns included in a single conductor for the purpose of the inter-device capacitance may be adaptively set by processor 402 of a user computer device 102, 202, or by user(s) of the devices, based on a desired data rate or a quantity of data to be exchanged. For example, a larger conductor, corresponding to a larger quantity of intersecting points in the touchscreen's electrode grid of rows and columns included in a single conductor, may tolerate a greater separation distance between two user computer devices or a greater misalignment between the devices but may provide a lower data rate in an exchange of data between the two devices over inter-device capacitances, as opposed to smaller, and more numerous, conductors that may allow for a greater data rate as data may be exchanged via each such conductor.

Temperature authentication between touching devices could constitute another means to trigger the touchscreen drivers 306 to reconfigure the capacitive grid pattern connection, creating in effect a single large conductive area (by connecting the rows and/or columns of the touchscreen electrodes, or subset of each, to act as one large conductor). This large conductor in effect enhances the coupling range between devices and alleviates the need for a tighter, more perfect alignment between devices. Data communication between devices then may be enabled, that is, initiated, by a temperature authentication of the other device (that is, detecting a predetermined temperature level of an external device, which predetermined temperature level is maintained by the at least one memory device of the detecting device). Data communication between devices also may be enabled, that is, initiated, by a manually input command such as a user pressing a button or touching a sensor of one or both of the sending and receiving devices or by a user inputting a voice command into one or both of the sending and receiving devices to commence communication between devices. Data communication also may be initiated via context-type sensors that sense a common physical context of the devices when an inter-device capacitance is detected (indicating that user computer devices, such as user computer devices 102 and 202, are in contact), for example, by a motion sensor of each device, such as an accelerometer, that senses matching accelerometer data between the user computer devices, or could be timer-triggered wherein a processor 302, 402, by reference to an associated timer 326, 410, initiates a data communication upon expiration of a given time period after detecting an inter-device capacitance.

Further, in response to detecting an inter-device capacitance between the two user computer devices, a processor 302 of a first user computer device of the two user computer devices 102, 202, such as user computer device 202, may generate a data stream that is converted to an alternating current signal by D/A 312 of the first user computer device. The first user computer device then conveys the alternating current signal to the corresponding capacitive touchscreen, that is, touchscreen 204, of the first user computer device, which in turn conveys the signal to the capacitive touchscreen of a second user computer device of the two user computer devices 102, 202, that is, user computer device 102 and corresponding touchscreen 104, via the inter-device capacitance. Again, in response to receiving the alternating current, the second user computer device 102 routes the alternating current to the corresponding processor 302 of the second user computer device via the corresponding A/D 314 for further processing. Similarly, the second user computer device 102 may convey an alternating current comprising a stream of data to the first user computer device 202 via touchscreen 104 of the second user computer device, the inter-device capacitance, and touchscreen 204 of the first user computer device.

The stream of data exchanged between the user's data input device 110, 202 and target user computer device 102 may comprise one or more of control data and user data. For example, and for the purpose of illustrating the principles of the present invention and not intending to limit the invention in any way, the exchanged data may be data transmitted by the user's data input device 110, 202 to target user computer device 102 and may comprise: authentication information, that is, data that allows the target user computer device to authenticate the user's data input device; data intended to control an operation of the target user computer device; and/or data intended to program and/or calibrate the target user computer device. By way of another example, the exchanged data may be data transmitted by the target communication device 102 to the user's data input device 110, 202 and may comprise: data intended to control an operation of the user's data input device and/or data intended to program and/or calibrate the user's data input device.

For example, the exchanged data may identify a type of stylus, such as a stylus made for use in China or a stylus made for use in the U.S., which stylus type would indicate, to target user computer device 102, a type of language employed by a user of the stylus, such as Chinese or English. Thus, a target user computer device capable of operating in multiple languages may be able to determine which of the multiple languages will be employed by a user of the stylus, facilitating the target user computer device's ability to interpret characters input by a user and/or to present to the user softkeys or text that are in the language of the user.

By way of another example, when touchscreen 104 of target user computer device 102 is a thermally sensitive touchscreen, the user's data input device 110, 202 may convey to target communication device 102 an instruction to pre-tune a temperature associated with the thermally sensitive touchscreen and/or a temperature level to which to pre-tune the touchscreen so that the user may use a finger to input instructions into the touchscreen instead of using the stylus.

By way of yet other examples, target user computer device 102 may convey to user computer device stylus 110 (or from one user computer device to the other user computer device 102, 202) data that is used to control stylus (or user computer device) functionality, for example, to program or calibrate the stylus or to cause a heat generator, for example, a battery (not shown) or (heat generating) processor 402, of a heat conducting stylus to output an appropriate temperature range to capacitive tip 112 such that a thermally sensitive touchscreen of the user computer device can detect the stylus for given environmental conditions (for example, ambient temperature). The data also could instruct that features or functions be enabled or disabled or could indicate a remaining power of the user computer device, a capability of the user computer device, a current operational mode of the user computer device that could cause the stylus to change a setting to match a setting of the user computer device, and so on. Or target user computer device 102 may convey data to user computer device stylus 110 that then is stored by the stylus in the at least one memory device 404 of the stylus. User computer device stylus 110 may later transfer the data to another target user computer device via an inter-device capacitance established with the another target user computer device, or the stylus may include an inter-device interface, such as a USB port, that will allow the stylus to transfer the stored data to any other user computer device or information processing system, for example, a personal computer, a laptop computer, or a tablet computer, that includes a same type of inter-device interface.

By way of yet other examples, communication from stylus 110 to target user computer device 102 or, again, between user computer devices 102, 202, could be used to set a user computer device display color, font, size, text style, language, and/or touch sensitivity. It could also cause a user computer device touchscreen to alter functionality so as to match that of the stylus. For example, different styluses could be used with a computer tablet, such as a stylus optimized for painting (paint brush), a stylus for writing, etc. In one such example, where the stylus is designed to conduct user grip temperature to the stylus tip (a heat conducting stylus), the stylus is able to communicate a user temperature to the user computer device touchscreen in response to the user gripping the stylus, so that if user suddenly decides to use fingers instead of stylus over the touch screen, the screen is already pre-tuned to user finger temperature.

By utilizing a capacitive coupling between user devices, that is, an inter-device capacitance between the user computer device touchscreens or between a user computer device touchscreen and a capacitive tip of a user computer device stylus, for data communications between the user devices, communication systems 100, 200 provide a short-range, highly secure exchange of data between user computer devices, such as between two mobile devices or a user computer device and a user computer device stylus, such as a mobile device and a mobile device stylus. Further, by allowing a user computer device stylus to exchange data with user computer device via a capacitive coupling of a capacitive tip of the stylus and a capacitive touchscreen of the user computer device, the communication systems provide for use of a smart stylus that stores data, self-configures, and self-generates instructions and configuration information that the stylus then provides to the user computer device. In addition, by utilizing the inter-device capacitance (as opposed to longer range wireless interfaces, for example, Bluetooth) for data communications, communications systems 100, 200 have the advantages of ad hoc communications, less susceptibility to the effects of environmental conditions, and proximity-based privacy of communication.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not without more constraints, preclude the existence of additional identical elements in the process, method, article, or apparatus that comprises, has, includes, contains the element. The terms “a” and “an” are defined as one or more unless explicitly stated otherwise herein. The terms “substantially,” “essentially,” “approximately,” “about,” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method for exchanging data with a user computer device, the method comprising:
creating an inter-device capacitance, wherein a capacitive touchscreen of the user computer device comprises a conductor of the inter-device capacitance; and
exchanging one or more streams of data with a device external to the user computer device via the capacitive touchscreen and the inter-device capacitance to produce one or more exchanged data streams.

2. The method of claim 1, wherein the one or more streams of data comprises one or more of control data and user data.

3. The method of claim 1, wherein the one or more streams of data comprises one or more of:
authentication information;
data intended to control an operation of the user computer device; and
data intended to one or more of program the user computer device and calibrate the user computer device.

4. The method of claim 1, wherein the one or more streams of data comprises data transmitted by the user computer device and wherein the data comprises one or more of:
data intended to control an operation of a user data input device;
data intended to one or more of program the user's data input device and calibrate the user's data input device.

5. The method of claim 1, wherein the one or more streams of data comprise one or more of:
an indication of a language type;
an indication of a stylus type;
an instruction to pre-tune a temperature associated with the capacitive touchscreen;
a temperature level to which to pre-tune the capacitive touchscreen;
data controlling a device functionality;
calibration data;
an indication of a power level of one or more of the user computer device and the external device;
data indicating a capability of one or more of the user computer device and the external device;
an instruction to enable a feature; and
an instruction to disable a feature.

6. The method of claim 1, further comprising reconfiguring a touchscreen capacitance formed by rows and columns of an electrode grid of a touchscreen of the user computer device to emulate one of a single conductor or a plurality of conductors.

7. The method of claim 6, wherein reconfiguring comprises determining a quantity of intersecting points of the rows and columns of the touchscreen's electrode grid grouped together to emulate one of a single conductor or a plurality of conductors based on one or more of a desired data rate and a quantity of data to be exchanged.

8. The method of claim 1, wherein the exchange of one or more streams of data over the inter-device capacitance is enabled by one or more of a temperature authentication between the user computer device and the external device, a manual command, a context-type detection, and an expiration of a timer.

9. A user computer device comprising
a capacitive touchscreen; and
a processor that is configured to establish an inter-device capacitance, via the capacitive touchscreen, with a device external to the user computer device and to exchange, with the device external to the user computer device and via the inter-device capacitance and the capacitive touchscreen, one or more streams of data to produce to produce one or more exchanged data streams.

10. The user computer device of claim 9, wherein the capacitive touchscreen is configured to operate as a conductor of the inter-device capacitance.

11. The user computer device of claim 9, wherein the processor is configured to detect a wireless communication device in proximity to the user computer device and, in response to detecting the wireless communication device, reconfigure the capacitive touchscreen so as to create a touchcreen that effectively operates as a single electrode.

12. The user computer device of claim 9, wherein the one or more streams of data comprises one or more of control signaling and user data.

13. The user computer device of claim 9, wherein the one or more streams of data comprises data transmitted by the user computer device and wherein the data comprises one or more of:
data intended to control an operation of a user data input device;
data intended to one or more of program the user's data input device and calibrate the user's data input device.

14. The user computer device of claim 9, wherein the one or more streams of data comprises one or more of:
authentication information;
data intended to control an operation of the user computer device; and
data intended to one or more of program the user computer device and calibrate the user computer device;
an indication of a language type;
an indication of a stylus type;
an instruction to pre-tune a temperature associated with the capacitive touchscreen;
a temperature level to which to pre-tune the capacitive touchscreen;
data controlling a device functionality;
calibration data;
an indication of a power level of one or more of the user computer device and the external device;
data indicating a capability of one or more of the user computer device and the external device;
an instruction to enable a feature; and
an instruction to disable a feature.

15. A communication system comprising:
a data input device having a capacitive user interface;
a user computer device having a capacitive touchscreen; and
wherein the data input device and the user computer device exchange one or more streams of data via an inter-device capacitance between the capacitive user interface of the data input device and the capacitive touchscreen of the user computer device.

16. The communication system of claim 15, wherein the user computer device comprises a mobile device.

17. The communication system of claim 16, wherein the user computer device is a first mobile device, the capacitive touchscreen is a first capacitive touchscreen, the data input device comprises a second mobile device, and the capacitive user interface comprises a second capacitive touchscreen.

18. The communication system of claim 15, wherein the data input device comprises a stylus having a capacitive tip.

19. The communication system of claim 15, wherein the one or more streams of data comprises data transmitted by the user computer device and wherein the data comprises one or more of:
data intended to control an operation of a user data input device;
data intended to one or more of program the user's data input device and calibrate the user's data input device.

20. The communication system of claim 15, wherein the one or more streams of data comprises one or more of:
authentication information;
data intended to control an operation of the user computer device; and
data intended to one or more of program the user computer device and calibrate the user computer device;
an indication of a language type;
an indication of a stylus type;
an instruction to pre-tune a temperature associated with the capacitive touchscreen;
a temperature level to which to pre-tune the capacitive touchscreen;
data controlling a device functionality;
calibration data;
an indication of a power level of one or more of the user computer device and the external device;
data indicating a capability of one or more of the user computer device and the external device;
an instruction to enable a feature; and
an instruction to disable a feature.
